(19) United States
(12) Patent Application Publication
(10) Pub. No.: US 2013/0062530 A1
(43) Pub. Date: Mar. 14, 2013

(54) BIOCHEMICAL MATERIAL DETECTION SYSTEM

(71) Applicant: Yu Chih CHANG, Taipei (TW)

(72) Inventor: Yu Chih CHANG, Taipei (TW)

(21) Appl. No.: 13/228,061

(22) Filed: Sep. 8, 2011

(51) Int. Cl. G01J 1/42; H01J 40/14

(52) U.S. Cl. 250/372; 250/216

(57) ABSTRACT

A biochemical material detection system is provided, which is used to detect biochemical materials. A material to be detected is placed above a sensor module in the system. A light source is guided in by a light emitting device to measure a refractive index of the material to be detected or other parameters related to the material to be detected. Furthermore, a heat source generated by the light emitting device in the system is further isolated outside the sensor module, thereby preventing the heat source from influencing a sensed result to improve the accuracy of the sensed result.

### BACKGROUND

1. Technical Field

The present invention relates to a biochemical material detection system for use in detection of biochemical materials, and more particularly to a biochemical material detection system capable of excluding a heat source of a light source to avoid influences on a detection result.

2. Related Art

Localized Surface Plasmon Resonance (LSPR) or Localized Plasmon Resonance (LPR) is widely used in measurement of interaction between chemical and biological properties and molecular scale. As a resonance frequency of LPR is highly correlated to the environment at the surface of metal nano-particles, and quite sensitive to the changes in the refractive index of solution in an external environment, or molecules bonded to the surface of the metal nano-particles. The times of light being absorbed may be increased by combining the existing LPR with a multiple reflection principle of an optical fiber, thereby enhancing then sensitivity of a sensor. Such a detection system is referred to as fiber optic-localized plasmon resonance (FO-LPR). Because the FO-LPR optical system is simpler than a conventional surface plasmon resonance system, the FO-LPR optical system is capable of miniaturization and decreasing the cost of the instrument, and arranged to have multiple channels, so as to analyze multiple materials to be tested simultaneously, and effectively improve the analysis efficiency. However, for any sensor based on optical principles, a problem of interferences on a measured signal exists due to background signal disturbance, which in turn influences the accuracy and reliability of measured test data. The changes of the ambient temperature most likely have direct influences. As shown in FIG. 1, in a conventional biochemical material detection system 10, a light emitting source 101 is mainly used as a start point of the optical detection. Light is directly transmitted through a light transmission element (optical fiber) 1021 and enters a light sensor element 102, so as to sense a material to be detected. However, for the existing biochemical material detection system 10, the light emitting source 101 is directly arranged at a coupling end of the light transmission element 1021, so that heat generated in generation of the light source directly influences the accuracy and reliability of data measured by an optical detector 103 at a terminal end of the system.

Referring to FIG. 2, currently the light sensor element 102 in a sensor can be modularized into a chip form, and may be fabricated into a replaceable and disposable detection chip module according to the requirements under different test conditions. However, in application, a measurement result is frequently influenced by a positioning error generated due to the positions of the light emitting source 101 and the light detector 103 after the light sensor element 102 (detection chip module) is replaced.

### SUMMARY

Accordingly, the present invention is mainly directed to a biochemical material detection system which can effectively isolate a heat source of a light emitting source, so as to prevent the heat source from influencing the accuracy and reliability of measured test data. To achieve the above objective, the present invention designs a light emitting device, in which a light source module and a first light transmission element form a front-end light incident path (channel), and at a rear end forms corresponding arrangement with a sensor module. Therefore, heat generated in light emission of the light source module can be kept away from the sensor module, while the light can still enter the sensor module through the first light transmission element. Thereby, the heat of the light emitting source can be effectively isolated, so as to prevent the heat from influencing test data measured by the sensor module, and effectively improve the accuracy and reliability of the measurement result.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic view of a structure of a conventional biochemical material detection system;

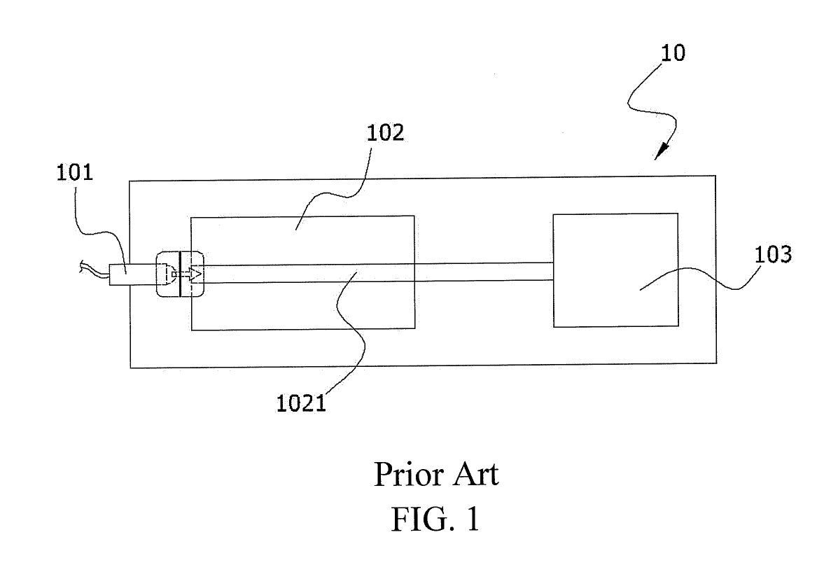

FIG. 2 is a schematic view of an implementation of a conventional biochemical material detection system;

FIG. 3 is a schematic view of a structure according to the present invention;

FIG. 4 is a schematic view of a light path in an implementation of the present invention;

FIG. 5 shows another exemplary embodiment of the present invention;

FIG. 6 shows another exemplary embodiment (1) of the present invention; and

FIG. 7 shows another exemplary embodiment (2) of the present invention.

### DETAILED DESCRIPTION

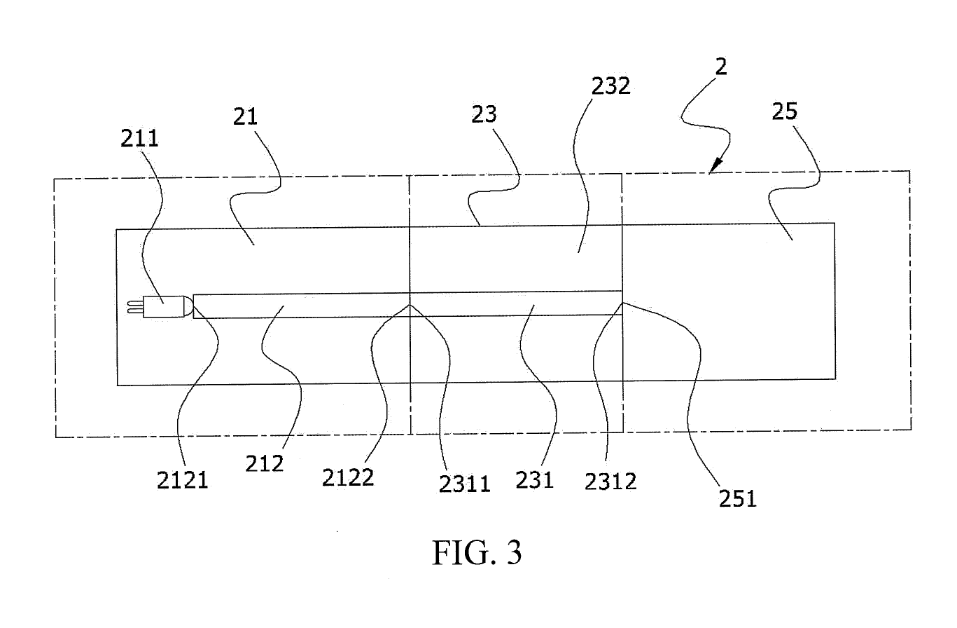

As shown in FIG. 3, a biochemical material detection system 2 is formed mainly by a light emitting device 21, a sensor module 23, and a light detection module 25. Referring to FIG. 3, the light emitting device 21 has a light source module 211, which may emit any one of a laser beam, visible light, and UV light and may be arranged at a light incident end 2121 of a first light transmission element 212, and the other end of the first light transmission element 212 forms a light emitting end 2122. The sensor module 23 is formed by a second light transmission element 231 and a light sensor element 232. A first optical coupling end 2311 and a second optical coupling end 2312 are respectively formed at two ends of the second light transmission element 231. The first optical coupling end 2311 is coupled to the light emitting end 2122 of the first light transmission element 212. The second light transmission element 231 is an optical fiber bare wire, a surface of which is coated with a layer of noble metal nano-particles. The light detection module 25 has a detection end 251. The detection end 251 is coupled to the second optical coupling end 2312 of the sensor module 23 for measuring light guided from the sensor module 23. Based on the above, a filter element, a light splitting element, or a coupling element may be added as desired in the whole light path, for example, between the light source module and the sensor module.

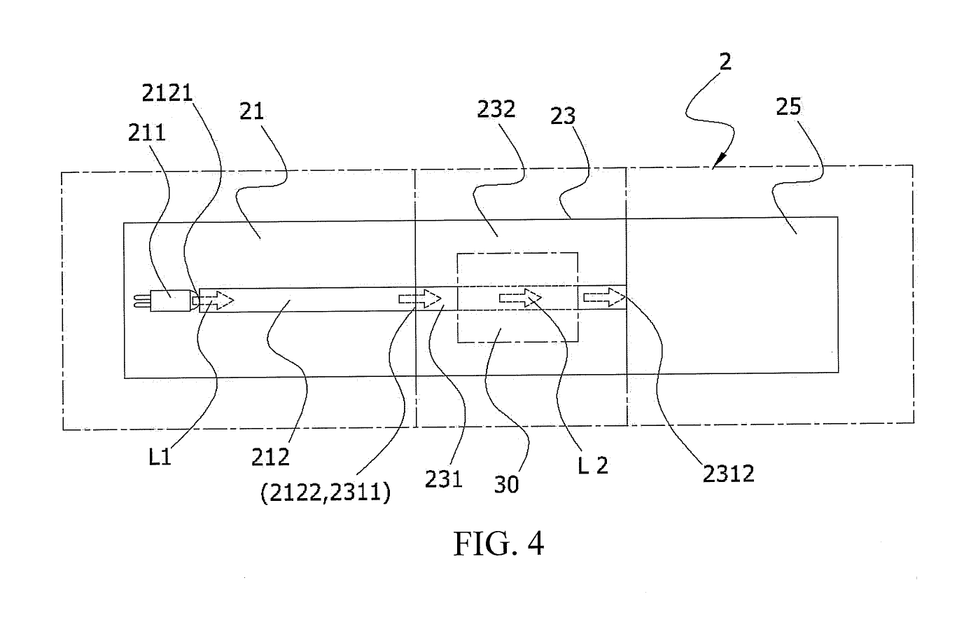

As shown in FIG. 4, in an implementation of the biochemical material detection system 2, a material to be detected 30 is positioned above the sensor module 23. At the beginning of the detection operation, the light source module 211 of the light emitting device 21 generates a light incident source L1, which enters through the light incident end 2121 of the first light transmission element 212, emits from the light emitting end 2122 at the other end thereof, and then passes through the sensor module 23 via the first optical coupling end 2311 of the second light transmission element 231. At this time, the light sensor element 232 of the sensor module 23 synchronously senses a reflected light L2 generated from the light incident source L1 passing through the sensor module 23. The reflected light L2 then enters the light detection module 25 via the second optical coupling end 2312. A detection end 251 of the light detection module 25 is connected (coupled) to the second optical coupling end 2312. In this manner, the guided reflected light L2 is measured by the light detection module 25. It can be seen that light is synchronously generated when the light source module 211 generates the light incident source L1. However, the heat is at the first optical coupling end 2311 of the first light transmission element 212, and thus does not directly contact the sensor module 23. Therefore, the purpose of keeping the heat away from the sensor module 23 is achieved, and the heat generated by the light incident source L1 is prevented from influencing the measurement results in light sensing and subsequent light detection.

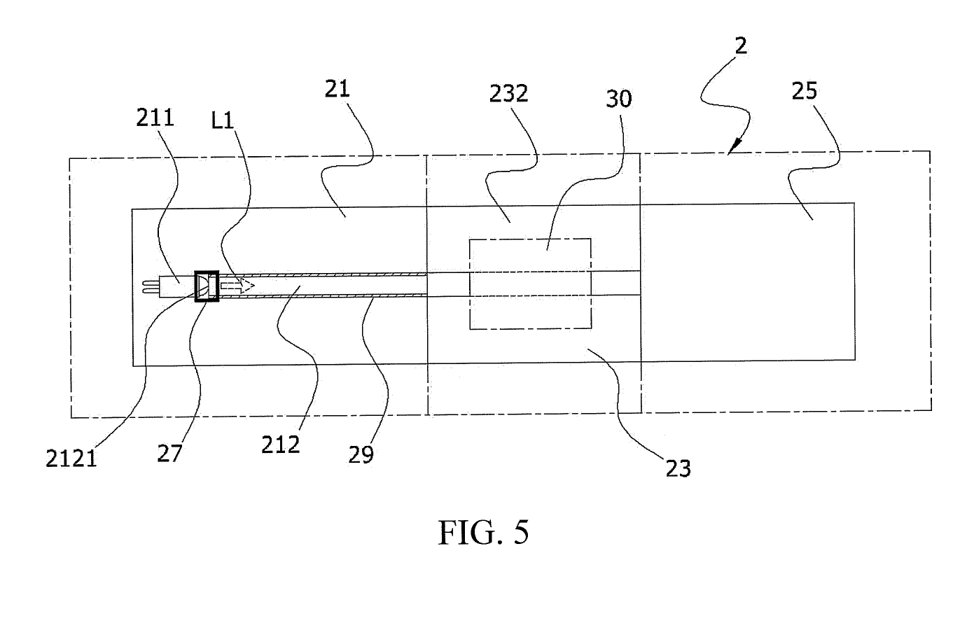

Referring to FIG. 5, based on the above, the biochemical material detection system 2 further has a heat dissipation ring 27 with a heat dissipation effect arranged at the light emitting end of the light source module 211 of the light emitting device 21, which may be made of a material having a high heat dissipation coefficient, such as aluminum, copper, or an alloy thereof. In this manner, the heat generated after generation of the light source is then rapidly dissipated through air in a conductive manner by the heat dissipation ring 27, thereby further reducing heat source remaining between the light source module 211 and the light incident end 2121 of the first light transmission element 212. Furthermore, the light source module 211 and the light incident end 2121 of the first light transmission element 212 may be arranged respectively at two ends of the heat dissipation ring 27. As shown in FIG. 5, in the present invention, a front-end surface or a whole surface of the first light transmission element 212 may be coated with a heat dissipation layer 29 having a heat dissipation effect, such that residual heat of the light incident source L1 is dissipated when passing through the first light transmission element 212, thereby preventing the heat from directly influencing the measurement results in light sensing and subsequent light detection.

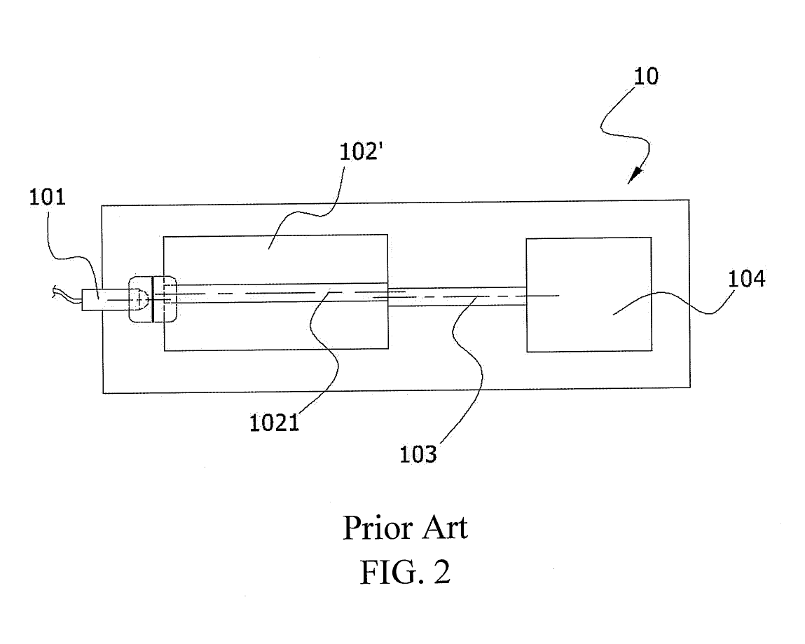

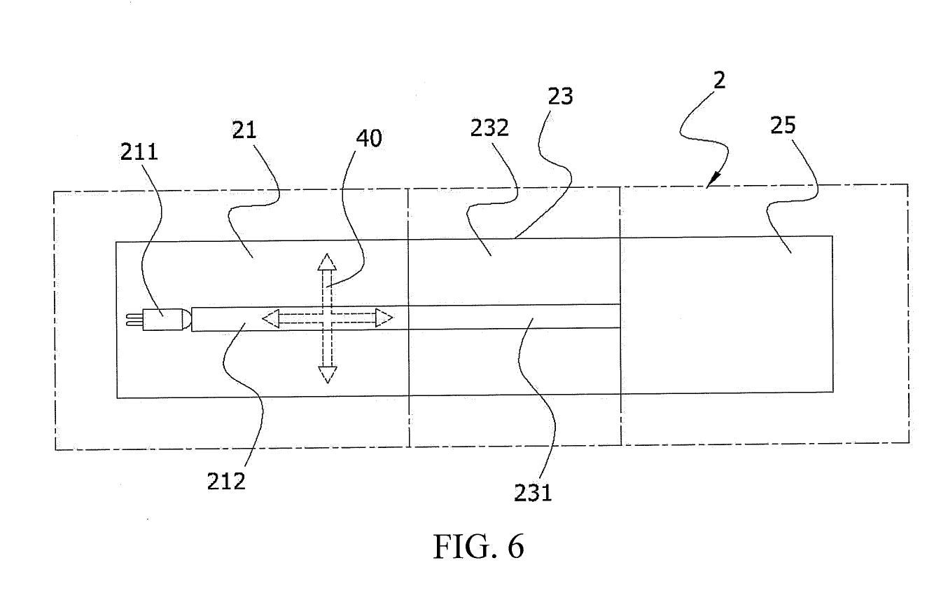

FIG. 6 shows another exemplary embodiment (1) of the present invention. As the current sensor module 23 is wholly modularized to have a chip form, the sensor module 23 used in the present invention may be a replaceable or disposable sensor module 23. However, after replacement of the sensor module 23, a problem of incapable of accurate positioning generally exists, which leads to distortion to measurement data (as shown in FIG. 2), and thus a position adjustment device 40 is further arranged at the light emitting device 21 of the present invention. After the sensor module 23 is arranged, the position of the light emitting device 21 may be adjusted by the position adjustment device 40, so that the light incident source L1 of the light source module 211 is co-axial with the second light transmission element 231 of the sensor module 23 during light emission. Moreover, the position adjustment device 40 may be a mono-axial or a multi-axial adjuster.

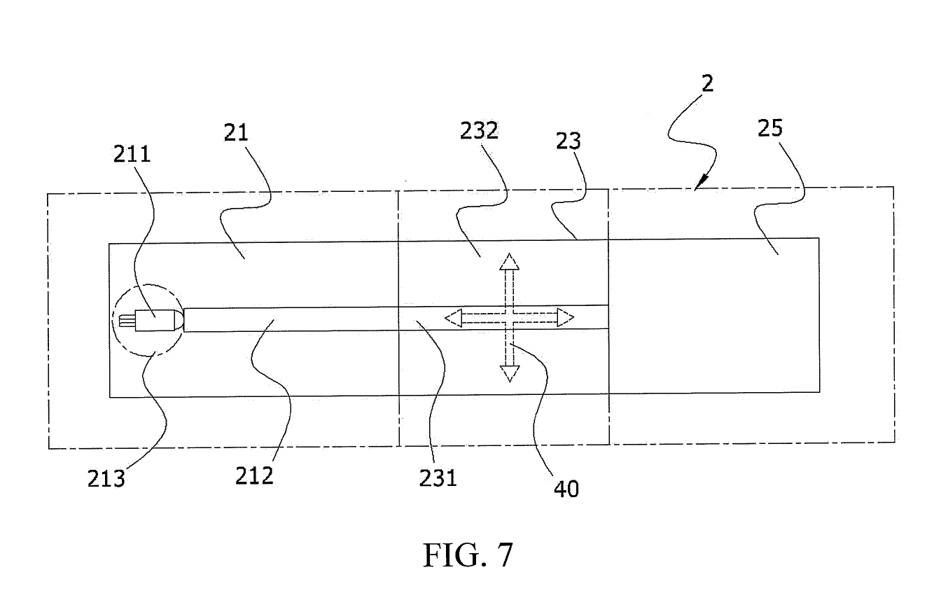

FIG. 7 shows another exemplary embodiment (2) of the present invention. The position adjustment device 40 makes the second light transmission element 231 of the sensor module 23 co-axial with the light source module 211 and the light detection module 25 after the sensor module 23 is replaced, and thus the position adjustment device 40 may also be arranged at the sensor module 23, so that after the sensor module 23 is replaced, the sensor module 23 may be adjusted to an accurate position by the position adjustment device 40. As shown in FIG. 7, the light source module 211 may be further arranged with an adjustment device 213, such that a light emitting angle of the light source module 211 may be properly adjusted as desired, and the adjustment device 213 may be a mono-axial or a multi-axial adjustment device. Furthermore, the light source module 211 may be used with other optical elements, for example, a lens and a spectroscope.

To sum up, in the present invention, the light incident source from the light source module of the light emitting device is transmitted to the sensor module mainly by using the light transmission element, while the heat in light emission of the light source module is effectively kept away from the sensor module, so as to prevent the heat from influencing the sensor module and the subsequent light detection module. In view of this, after the implementation of the present invention, the purpose of providing a biochemical material detection system capable of preventing the heat source from influencing the accuracy and reliability of the measured test data by effectively isolating the heat source of the light emitting source can be actually achieved.

However, the descriptions above are only exemplary embodiments of the present invention, and not intended to limit the scope of the present invention. Any equivalent changes and modifications made by persons of skill in the art without departing from the spirit and scope of the present invention shall be covered in the scope of the present invention.

What is claimed is:

1. A biochemical material detection system, comprising:
a light emitting device, having a light source module, wherein the light emitting device is arranged at a light incident end of a first light transmission element, and the other end of the first light transmission element forms a light emitting end;
a sensor module, formed by a second light transmission element and a light sensor element, wherein a first optical coupling end and a second optical coupling end are respectively formed at two ends of the second light transmission element, and the first optical coupling end is coupled to the light emitting end of the first light transmission element; and
a light detection module, having a detection end, wherein the detection end is coupled to the second optical coupling end of the second light transmission element of the sensor module, so as to measure light guided from the sensor module;
wherein a light source generated by the light source module of the light emitting device enters through the light incident end of the first light transmission element, enters the sensor module through the light emitting end of the first light transmission element and the first optical coupling end of the second light transmission element, and then reaches the light detection module through the second optical coupling end of the second light transmission element, so that a heat source generated by the light source module is kept away from the sensor module.

2. The biochemical material detection system according to claim 1, wherein a position adjustment device is arranged at the light emitting device for adjusting a position of an incident light source of the light source module.

3. The biochemical material detection system according to claim 2, wherein the position adjustment device is a mono-axial adjuster.

4. The biochemical material detection system according to claim 2, wherein the position adjustment device is a multi-axial adjuster.

5. The biochemical material detection system according to claim 1, wherein a position adjustment device is arranged at the sensor module for adjusting a position of the sensor module.

6. The biochemical material detection system according to claim 5, wherein the position adjustment device is a mono-axial adjuster.

7. The biochemical material detection system according to claim 5, wherein the position adjustment device is a multi-axial adjuster.

8. The biochemical material detection system according to claim 1, wherein a surface of the first light transmission element is coated with a heat dissipation layer.

9. The biochemical material detection system according to claim 1, wherein a heat dissipation ring having a heat dissipation effect is arranged at the light source module.

10. The biochemical material detection system according to claim 1, wherein the second light transmission element of the sensor module is an optical fiber bare wire and a surface of the optical fiber bare wire is coated with a layer of noble metal nano-particles.

11. The biochemical material detection system according to claim 1, wherein the light sensor element of the sensor module is a chip having a sensing function.

12. The biochemical material detection system according to claim 1, wherein the light source module emits any one of a laser beam, visible light, and UV light.

13. The biochemical material detection system according to claim 1, wherein a filter element is arranged between the light source module and the sensor module.

14. The biochemical material detection system according to claim 1, wherein a light splitting element is arranged between the light source module and the sensor module.

15. The biochemical material detection system according to claim 1, wherein a coupling element is arranged at the light emitting end of the first light transmission element.

16. The biochemical material detection system according to claim 1, wherein the light source module is arranged together with an adjustment device, so that a light emitting angle of the light source module is adjusted as desired.

17. The biochemical material detection system according to claim 16, wherein the adjustment device is a mono-axial adjustment device.

18. The biochemical material detection system according to claim 16, where the adjustment device is a multi-axial adjustment device.
